(19) United States
(12) Patent Application Publication
(10) Pub. No.: US 2018/0324600 A1
(43) Pub. Date: Nov. 8, 2018

(54) ANALOG BEAMFORMING FOR WI-FI DEVICES

(71) Applicant: Intel Corporation, Santa Clara, CA (US)

(72) Inventors: Carlos Aldana, Santa Clara, CA (US); Yaron Alpert, Hod Hasharon (IL); Ali Sadri, San Diego, CA (US); Alexander Maltsev, Nizhny Novgorod (RU)

(21) Appl. No.: 15/971,790

(22) Filed: May 4, 2018

Related U.S. Application Data
(60) Provisional application No. 62/501,355, filed on May 4, 2017.

(51) Int. Cl. H04W 16/28; H04W 74/08

(52) U.S. Cl. CPC H04W 16/28; H04W 84/12; H04W 74/0808

(57) ABSTRACT

This disclosure describes systems, methods, and devices related to analog beamforming for Wi-Fi devices. A device may determine a first analog direction associated with a first antenna of one or more antennas, using an RF chain. The device may determine a second analog direction associated with a second antenna of the one or more antennas, using the RF chain. The device may cause to send a first frame of one or more frames to a responder device using the first analog direction. The device may cause to send a second frame of the one or more frames to the responder device using the second analog direction. The device may identify one or more response frames received from the responder device, wherein at least one of the one or more response frames comprises an indication of an identified transmit direction.

### CROSS-REFERENCE TO RELATED APPLICATIONS

This application claims the benefit of U.S. Provisional Application 62/501,355, filed May 4, 2017, the disclosure of which is incorporated herein by reference as if set forth in full.

### TECHNICAL FIELD

This disclosure generally relates to systems and methods for wireless communications and, more particularly, to analog beamforming for Wi-Fi devices.

### BACKGROUND

Wireless devices are becoming widely prevalent and are increasingly requesting access to wireless channels. The Institute of Electrical and Electronics Engineers (IEEE) is developing one or more 802.11 standards that utilize Orthogonal Frequency-Division Multiple Access (OFDMA) in channel allocation. The 802.11 standard lacks directional beamforming for Wi-Fi devices operating in 2.4 GHz, 5 GHz, or 6 GHz.

### BRIEF DESCRIPTION OF THE DRAWINGS

FIG. 1 depicts a network diagram illustrating an example network environment for analog beamforming, according to one or more example embodiments of the disclosure.

FIG. 2 depicts an illustrative schematic diagram for analog beamforming, in accordance with one or more example embodiments of the present disclosure.

FIG. 3 depicts an illustrative schematic diagram for analog beamforming, in accordance with one or more example embodiments of the present disclosure.

FIG. 4 depicts an illustrative schematic diagram for analog beamforming, in accordance with one or more example embodiments of the present disclosure.

FIGS. 5A-5B depict flow diagrams of illustrative processes for an illustrative analog beamforming system, in accordance with one or more example embodiments of the present disclosure.

FIG. 6 depicts a functional diagram of an example communication station that may be suitable for use as a user device, in accordance with one or more example embodiments of the present disclosure.

FIG. 7 depicts a block diagram of an example machine upon which any of one or more techniques (e.g., methods) may be performed, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

There is a significant demand for high data rates in wireless backhaul networks. High data rates are currently provided by an IEEE 802.11 wireless local area network (WLAN). Digital beamforming in IEEE 802.11 is a great way to improve the range of the system. In millimeter wave (mmWave), digital beamforming is prohibitively complex because of the required number of radio frequency (RF) chains, analog-to-digital converters, and digital-to-analog converters. Beamforming in mmWave is typically done with a single RF chain and with analog phase shifters. There is currently no standards based solution in the market that takes IEEE 802.11 products in 2.4 and 5 GHz and applies analog beamforming for a backhaul solution. That is, IEEE 802.11 has no standards based mode that allows for devices operating in frequency bands of 2.4 GHz, 5 GHz, or 6 GHz to directionally beamform with each other.

Example embodiments of the present disclosure relate to systems, methods, and devices for analog beamforming in 802.11 devices (e.g., 2.4 GHz, 5 GHz, or 6 GHz devices).

In one embodiment, an analog beamforming system may facilitate using IEEE 802.11 (e.g., 2.4 GHz, 5 GHz, or 6 GHz devices) as its foundation. Some examples of these frames may be request to send (RTS) and/or clear to send (CTS) or any management frame or acknowledgment (ACK). There are no known solutions standards based that are simple and easy to implement to address directional beamforming in 802.11 solutions using a similar use case as mmWave.

In one or more embodiments, an analog beamforming system may facilitate an analog hybrid beamforming scheme that is applicable for Wi-Fi products that are based on 802.11 (e.g., 2.4 GHz, 5 GHz, or 6 GHz).

Multiple antennas may use the same hardware to process the radio signal. In this case, only one antenna can transmit or receive at a time because all radio signals need to go through the single RF chain. In multiple-input, multiple-output (MIMO), there can be a separate RF chain for each antenna allowing multiple RF chains to coexist. However, there are hardware limitations to the number of RF chains compared to having additional antennas. That is, an 802.11 device (e.g., 2.4 GHz, 5 GHz, or 6 GHz device) could have a larger number of antennas than RF chains.

A typical Wi-Fi router has four antennas and four RF chains, and streams can be transmitted on all four RF chains. However, a situation arises when additional antennas are available but the number of RF chains stay the same. For example, there are four RF chains but there are eight antennas that are available. Although the four RF chains are used, the additional antennas may also be used.

In one or more embodiments, an analog beamforming system may perform a link acquisition mechanism using one or more 802.11 frames (e.g., 2.4 GHz, 5 GHz, or 6 GHz frames). For example, an initiator may begin by sending multiple request to send (RTS) frames each in a different direction. The responder may listen in an omnidirectional mode. As soon as the responder hears one successful RTS frame, then the responder sends it clear to send (CTS) frame. That is, the initiator may not have sent the RTS frames on all antennas in all directions but only a subset of the antennas and the directions. The initiator in effect may be waiting to determine the direction in which an RTS frame is received successfully on the responder side. The responder sends a CTS frame when it successfully receives one of the RTS frames sent from the initiator. Once the initiator receives a CTS frame from the responder, it keeps the direction for which it transmitted the successful RTS frame and uses it for receiving additional frames coming from the responder. The responder may then performs it sweep by sending multiple RTS frames each in a different direction. Note that to add robustness, multiple RTS frames could be sent in the same direction. The initiator would then send its CTS frame using the direction that it used when it transmitted the successful RTS frame.

The analog beamforming allows the RTS frames to be sent with a sharp beam because of the additional antennas compared to the RF chains. The more antennas that are used, the sharper the beam. However, an analog beamforming system may facilitate exciting different directions using 802.11 frames, such as RTS, CTS, or any management or acknowledgment frames (e.g., 2.4 GHz, 5 GHz, or 6 GHz frames).

In one or more embodiments, an analog beamforming system may facilitate that each RTS frame is sent by the initiator in a specific transmit direction, and the initiator may set the receive direction to be the same as the transmit direction.

In one or more embodiments, an analog beamforming system may determine to send (or excite) a frame (e.g., an RTS frame) in a direction associated with an antenna using analog beamforming even though there is, for example, one RF chain.

In one or more embodiments, if there are more antennas than RF chains, each of the antennas may switch to a different direction while being linked to the RF chains. For example, if there is one RF chain but there are four antennas, each of the four antennas may have a specific direction while still being linked to the same RF chain.

In one or more embodiments, an initiator may send one or more frames (e.g., RTS frames) in one or more analog directions, where each analog direction is linked to the same RF chain. An analog direction may be associated with an analog chain that may be accomplished by varying antenna parameters to direct the antenna in a specific direction, referred to hereinafter as analog direction. The responder may then send one or more response frames (e.g., CTS frames) omnidirectionally. The initiator here may perform a complete sweep of all its antennas using analog directions and wait for feedback on which of these analog directions is the best direction for sending and receiving additional frames. After the responder sends its one or more response frames, it sends a feedback frame to the initiator. The feedback frame is a physical layer (PHY) protocol data unit (PPDU) that indicates which direction is the best direction for receiving one of the RTS frames. The initiator may receive the feedback omnidirectionally and may determine from the feedback the best direction and uses that direction to send its acknowledgment frame to the feedback frame. Following that, the responder may then perform its own sweep of the RTS frames sent to the initiator by sweeping all of its antennas using analog directions. The initiator would then send response frames in the determined best analog direction and also listens for incoming frames using that same analog direction. The initiator would then determine a direction for the RTS frames received from the responder that is the best direction and reports that to the responder in a feedback frame. The feedback frame may be sent using the initiator's best direction that was determined from the first feedback frame received from the responder. The responder may listen for the feedback frame omnidirectionally. The responder may determine its own best direction, which is indicated in the received feedback frame. The responder may then send an acknowledgment using that best direction.

In one or more embodiments, an initiator may send one or more frames (e.g., RTS frames) in one or more analog directions, where each analog direction is linked to the same RF chain. The initiator here may perform a complete sweep of all of its antennas using analog directions when sending the one or more frames. The responder may then send one or more response frames (e.g., CTS frames) omnidirectionally. In this scenario, instead of sending a feedback frame from the responder to the initiator indicating the best analog direction of one of the received RTS frames, the responder may send a sweep of feedback frames in all analog directions using the same RF chain. One issue with sending RTS frames is that it prevents other neighboring devices from communicating during the time the RTS frames are being sent. In order to minimize that limitation, instead of sending a sweep of RTS frames from the responder to the initiator, the responder sends a sweep of feedback frames to the initiator. The sweep of feedback frames comprises an indication of the best analog direction of the most recently RTS frames sent from the initiator. Similarly, the initiator responds by sending, omnidirectionally, acknowledgment frames to the feedback frames received from the responder and also sends a feedback frame comprising an indication of the best analog direction of the sweep of feedback frames received from the responder. The initiator sends the feedback frame in the same direction that was indicated as the best analog direction of the RTS frames sent from the initiator in the previous timeslot. The responder listens for the feedback frame from the initiator omnidirectionally because it still does not know what its best analog direction is. Once the responder receives the feedback frame, the responder determines, based on information included in the feedback frame, which direction is its best analog direction to use for sending frames. The responder may then respond to the feedback frame received from the initiator by sending an acknowledgment using that best analog direction.

The above descriptions are for purposes of illustration and are not meant to be limiting. Numerous other examples, configurations, processes, etc., may exist, some of which are described in detail below. Example embodiments will now be described with reference to the accompanying figures.

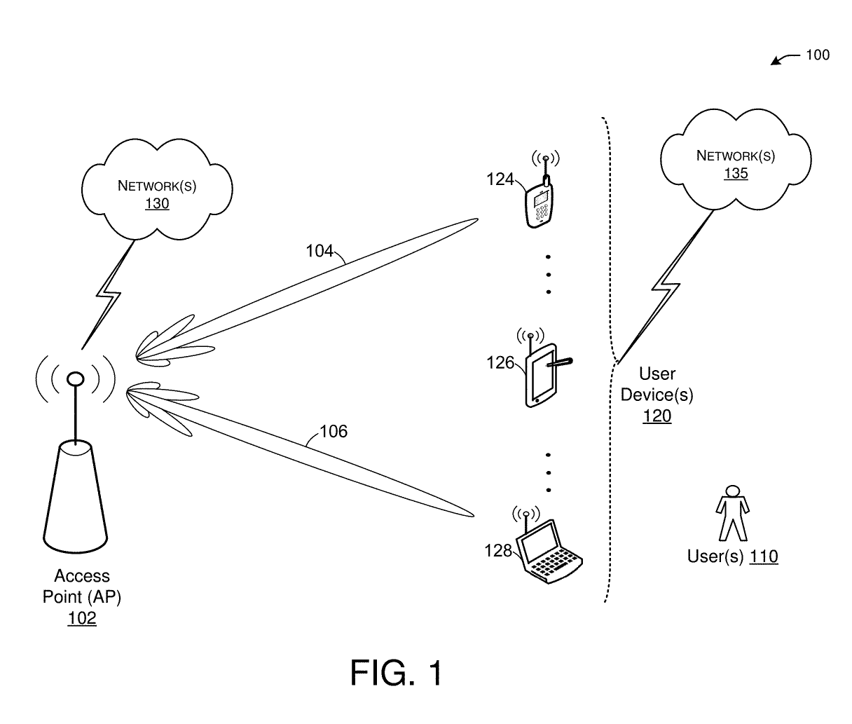

FIG. 1 is a network diagram illustrating an example network environment, according to some example embodiments of the present disclosure. Wireless network 100 may include one or more user device(s) 120 and one or more access point(s) (AP) 102, which may communicate in accordance with IEEE 802.11 communication standards. For example, the one or more user device(s) 120 and the one or more access point(s) (AP) 102d may communicate according to 2.4 GHz, 5 GHz, or 6 GHz frequencies bands in 802.11.

In some examples, the user device(s) 120 may be mobile devices that are non-stationary and do not have fixed locations.

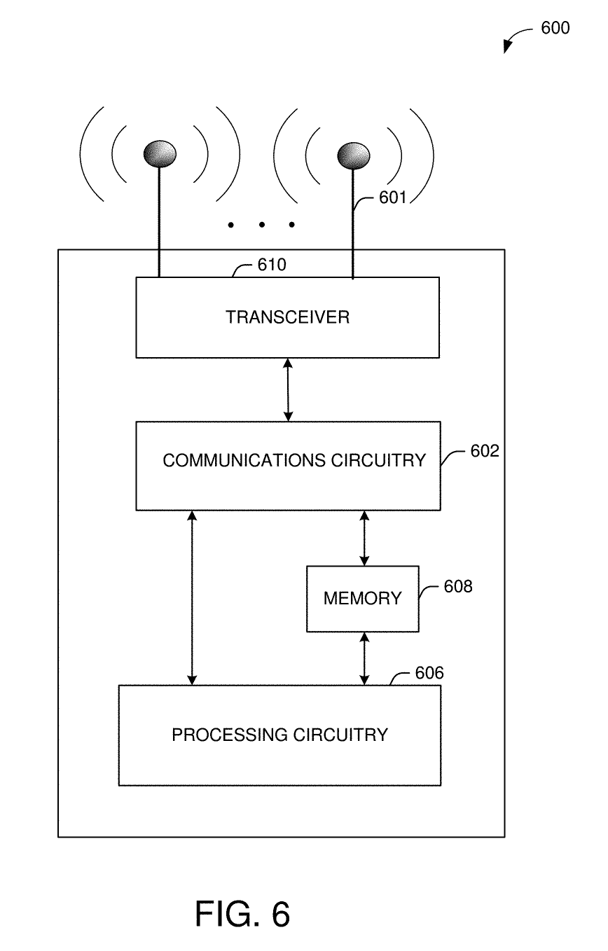

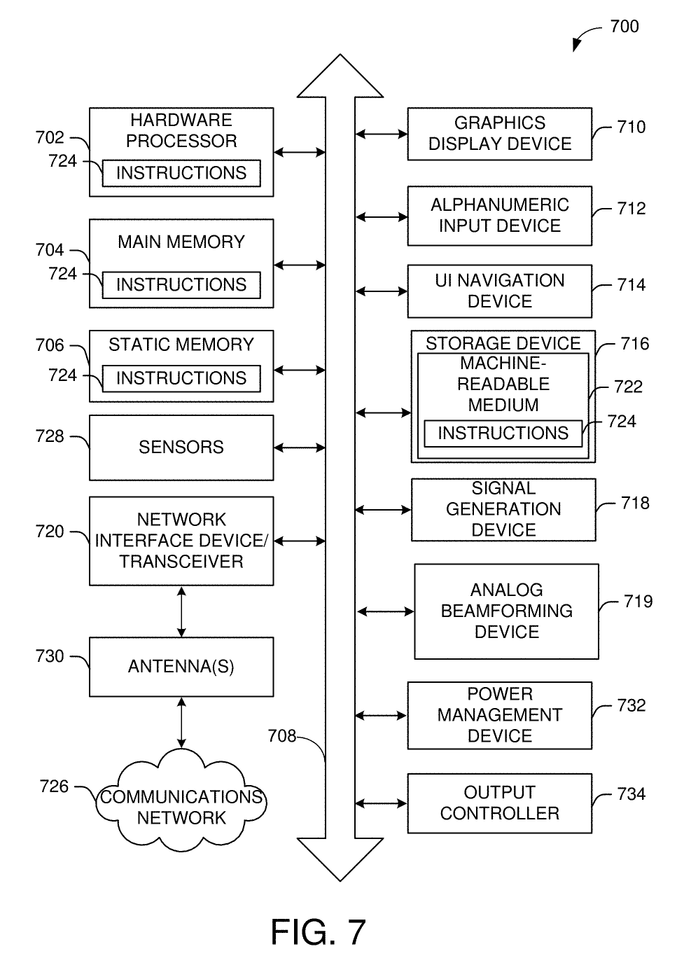

In some embodiments, the user device(s) 120 and AP 102 may include one or more computer systems similar to that of the functional diagram of FIG. 6 and/or the example machine/system of FIG. 7.

One or more illustrative user device(s) 120 and/or AP 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 120 and the AP(s) 102 may be STAs. The one or more illustrative user device(s) 120 and/or AP 102 may operate as a personal basic service set (PBSS) control point/access point (AP/PCP). The user device(s) 120 (e.g., 124, 126, or 128) and/or AP 102 may include any suitable processor-driven device including, but not limited to, a mobile device or a non-mobile, e.g., a static, device. For example, user device(s) 120 and/or AP 102 may include, for example, an 802.11 device operating at 2.4 GHz, 5 GHz, or 6 GHz, a DMG device, an EDMG device, a UE, an MD, a station (STA), an access point (AP), a personal computer (PC), a wearable wireless device (e.g., bracelet, watch, glasses, ring, etc.), a desktop computer, a mobile computer, a laptop computer, an ultrabook^{t}m computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like.

Any of the user device(s) 120 (e.g., user devices 124, 126, 128), and AP 102 may be configured to communicate with each other via one or more communications networks 130 and/or 135 wirelessly or wired. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128), and AP 102 may include one or more communications antennas. Communications antenna may be any suitable type of antenna corresponding to the communications protocols used by the user device(s) 120 (e.g., user devices 124, 126, and 128), and AP 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, or the like. The communications antenna may be communicatively coupled to a radio component to transmit and/or receive signals, such as communications signals to and/or from the user device(s) 120.

Any of the user device(s) 120 (e.g., user devices 124, 126, 128), and/or AP 102 may include any suitable radio and/or transceiver for transmitting and/or receiving radio frequency (RF) signals in the bandwidth and/or channels corresponding to the communications protocols utilized by any of the user device(s) 120 and/or AP 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g., 802.11b, 802.11g, 802.11n, and 802.11ax), 5 GHz channels (e.g., 802.11n, 802.11ac, and 802.11ax), 6 GHz channels, or 60 GHz channels (e.g., 802.11ad, 802.11ay). In some embodiments, non-Wi-Fi protocols may be used for communications between devices, such as Bluetooth, dedicated short-range communication (DSRC), Ultra-High Frequency (UHF) (e.g., IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

Some specifications, e.g., an IEEE 802.11ad specification, may be configured to support a single user (SU) system, in which an STA cannot transmit frames to more than a single STA at a time. Such specifications may not be able, for example, to support a STA transmitting to multiple STAs simultaneously, for example, using a multi-user MIMO (MU-MIMO) scheme, e.g., a downlink (DL) MU-MIMO, or any other MU scheme.

In some demonstrative embodiments, user device(s) 120 and/or AP 102 may be configured to implement one or more multi-user (MU) mechanisms. For example, user device(s) 120 and/or AP 102 may be configured to implement one or more MU mechanisms, which may be configured to enable MU communication of Downlink (DL) frames using a Multiple-Input-Multiple-Output (MIMO) scheme, for example, between a device, e.g., AP 102, and a plurality of user devices, e.g., including user device(s) 120 and/or one or more other devices.

In some demonstrative embodiments, and/or AP 102 may be configured to communicate over a Next Generation 60 GHz (NG60) network, an Extended DMG (EDMG) network, and/or any other network. For example, and/or AP 102 may be configured to communicate MIMO, e.g., DL MU-MIMO, transmissions and/or use channel bonding, for example, for communicating over the NG60 and/or EDMG networks.

In some demonstrative embodiments, and/or AP 102 may be configured to support one or more mechanisms and/or features, for example, channel bonding, single user (SU) MIMO, and/or and multi-user (MU) MIMO, for example, in accordance with an EDMG Standard, an IEEE 802.11ay standard and/or any other standard and/or protocol.

In one embodiment, and with reference to FIG. 1, an initiator (e.g., AP 102) may be configured to communicate using SU and/or MU MIMO technique, for example, using one or more 802.11 frames (e.g., 2.4 GHz, 5 GHz, or 6 GHz frames) with one or more responders (e.g., non-AP STAs, such as, user devices 120).

For example, in order for the AP 102 to establish a communication (e.g., an MU-MIMO communication) with one or more user devices 120 (e.g., user device 124 and user device 128 using beams 104 and 106 respectively). The AP 102 may perform beamforming training with the one or more user devices 120.

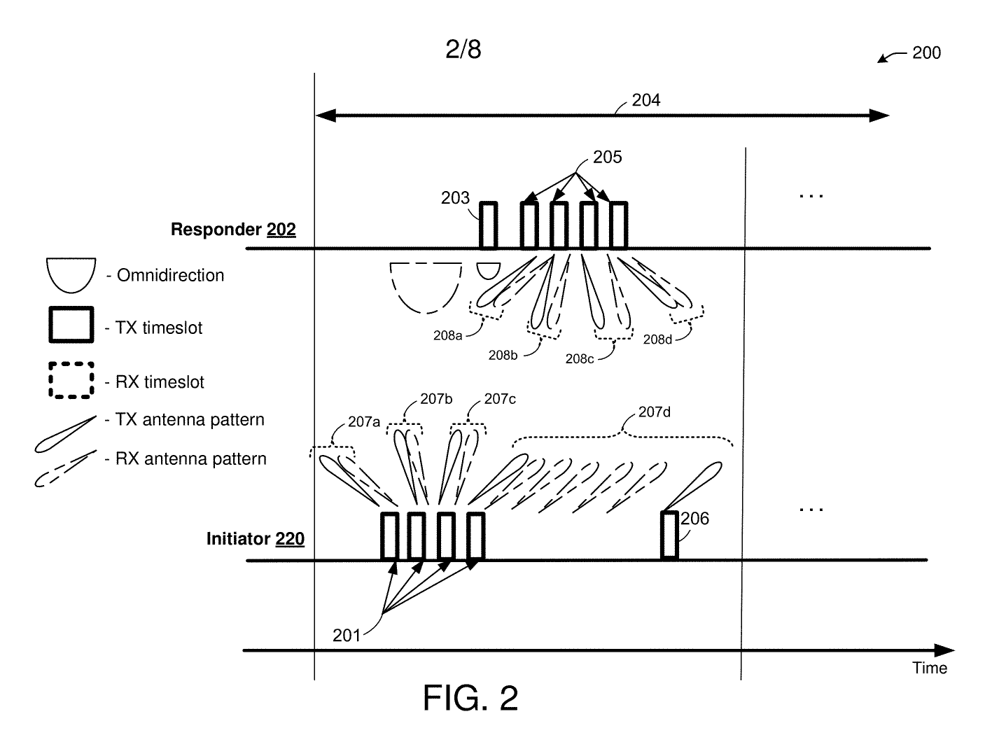

FIG. 2 depicts an illustrative schematic diagram 200 for analog beamforming, in accordance with one or more example embodiments of the present disclosure.

Referring to FIG. 2, there is shown a first phase 204 that may consist of link acquisition using analog beamforming. In FIG. 2 there is shown a responder device 202 and an initiator device 220 (e.g., the user devices 120 of FIG. 1 and/or the AP 102 of FIG. 1) that may be communicating with each other by sending and/or receiving one or more frames in one or more analog directions (also referred to as analog chains). The initiator device 220 and the responder device 202 may comprise one or more RF chains and one or more antennas. In this example, the number of RF chains is less than or equal to the number of antennas on each of the initiator device 220 and the responder device 202. The initiator device 220 and the responder device 202 may be 802.11 devices (e.g., 2.4 GHz, 5 GHz, or 6 GHz devices).

In one or more embodiments, in the first phase 204, the initiator device 220 may send a coarse acquisition transmission (e.g., RTS frames 201) in several spatial directions (e.g., directions 207a, 207b, 207c, 207d). These RTS frames 201 may have identical duration field values. The initiator device 220 may send RTS 201 frames each in a certain direction and may use the exact same antenna pattern for the possible reception of the incoming CTS frame 203. When the responder device 202 detects the first coarse acquisition, it may send a response. This response may take the form of a CTS frame (e.g., CTS frame 203) or an acknowledgment (ACK) frame. Then the responder device 202 may send a set of coarse acquisition transmissions (e.g., RTS frames 205) to the initiator device 220. When the initiator device 220 detects the signals (e.g., RTS frames 205), it may send a response frame (e.g., a CTS frame 206). This response may take the form of a CTS frame or an ACK frame.

In one or more embodiments, an analog beamforming system may perform a link acquisition mechanism using one or more 802.11 frames (e.g., 2.4 GHz, 5 GHz, or 6 GHz frames). For example, the initiator device 220 may send multiple RTS frames 201 each in a different direction. The responder device 202 may listen in an omnidirectional mode. As soon as the responder device 202 hears one successful RTS frame of the RTS frames 201, then the responder device 202 sends a response frame (e.g., CTS frame 203). That is, the initiator device 220 may not have sent the RTS frames 201 on all antennas in all directions but only a subset of the antennas and the directions. The initiator device 220 in effect may be waiting to determine the direction at which an RTS frame of the RTS frames 201 is received successfully on the responder side. The responder device 202 may send a CTS frame 203 when it successfully receives one of the RTS frames 201 sent from the initiator device 220. Once the initiator device 220 receives the CTS frame 203 from the responder device 202, it keeps the direction (e.g., direction 207d) for which it transmitted the successful RTS frame of the RTS frames to align and uses it for receiving additional frames coming from the responder device 202. The responder device 202 then performs its sweep by sending multiple RTS frames (e.g., RTS frames 205) each in a different direction (e.g., directions 208a, 208b, 208c, 208d). The initiator device 220 would then send its CTS frame (e.g., CTS frame 206) using the direction 207d that it used when it transmitted the successful RTS frame of the RTS frames 201.

It is understood that the above descriptions are for purposes of illustration and are not meant to be limiting.

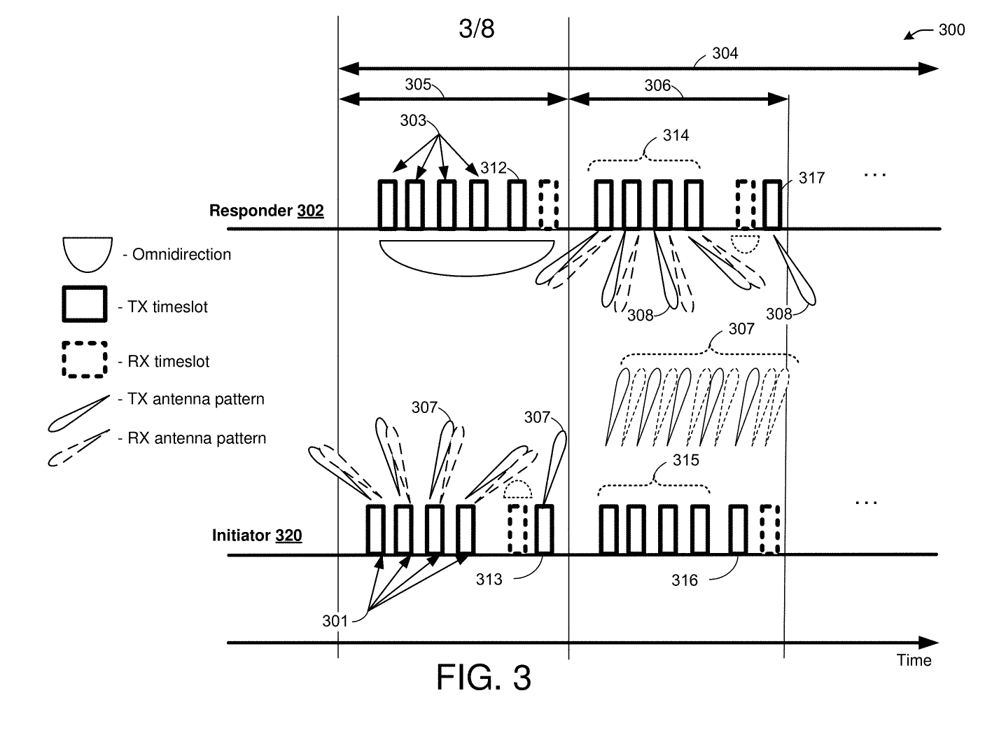

FIG. 3 depicts an illustrative schematic diagram 300 for analog beamforming, in accordance with one or more example embodiments of the present disclosure.

Referring to FIG. 3, there is shown a first phase 304 that may consist of link acquisition using analog beamforming. Two timeslots are shown, timeslot 305 and timeslot 306.

In timeslots 305 and 306, an initiator device 320 and a responder device 302 (e.g., the user devices 120 of FIG. 1 and/or the AP 102 of FIG. 1) may be communicating with each other by sending and/or receiving one or more frames in one or more analog directions (also referred to as analog chains). The initiator device 320 and the responder device 302 may comprise one or more RF chains and one or more antennas. In this example, the number of RF chains is less than or equal to the number of antennas on each of the initiator device 320 and the responder device 302. The initiator device 320 and the responder device 302 may be 802.11 devices (e.g., 2.4 GHz, 5 GHz, or 6 GHz devices).

A drawback of diagram 200 of FIG. 2 is that the direction found may not be a desired one. Instead, an analog beamforming system may allow the initiator device (e.g., initiator device 320) to sweep through all directions and have a feedback frame from the responder device (e.g., responder device 302) to indicate the desired direction.

In one or more embodiments, in timeslot 305, the initiator device 320 may send one or more frames (e.g., RTS frames 301) in one or more analog directions, where each analog direction is linked to the same RF chain. The responder device 302 may then send one or more response frames (e.g., CTS frames 303) omnidirectionally. The initiator device 320 in this case may perform a complete sweep of all of its antennas using analog directions and wait for feedback on which of these analog directions is the best direction for sending and receiving additional frames. After the responder device 302 sends its one or more response frames (e.g., CTS frames 303), it sends a feedback frame 312 to the initiator device 320. The feedback frame 312 may be a physical layer (PHY) protocol data unit (PPDU) that indicates which direction is the best direction for receiving one of the RTS frames 301. The initiator device 320 may receive the feedback frame 312 omnidirectionally, may determine from the feedback frame 312 the best direction (e.g., direction 307) for its antennas, and uses that direction to send its acknowledgment frame 313 to acknowledge receiving the feedback frame 312. Following that, the responder device 302 may then perform its own sweep of RTS frames 314 sent to the initiator device 320 by sweeping all of its antennas using analog directions during timeslot 306. The initiator device 320 may then send response frames (e.g., CTS frames 315) in the determined best analog direction and listens for incoming frames using that same analog direction. The initiator device 320 would then determine a direction for the RTS frames 314 received from the responder device 302 that is the best direction (e.g., direction 308) and reports that to the responder in a feedback frame 316. The feedback frame 316 may be sent using the initiator device 320's best direction (e.g., direction 307) that was determined from the feedback frame 312 received from the responder device 302 during timeslot 305. The responder device 302 may listen for the feedback frame 316 omnidirectionally. The responder device 302 may determine its own best direction (e.g., direction 308) which is indicated in the received feedback frame 316. The responder device 302 may then send an acknowledgment (e.g., ACK 317) using that best direction 308. It is understood that the above descriptions are for purposes of illustration and are not meant to be limiting.

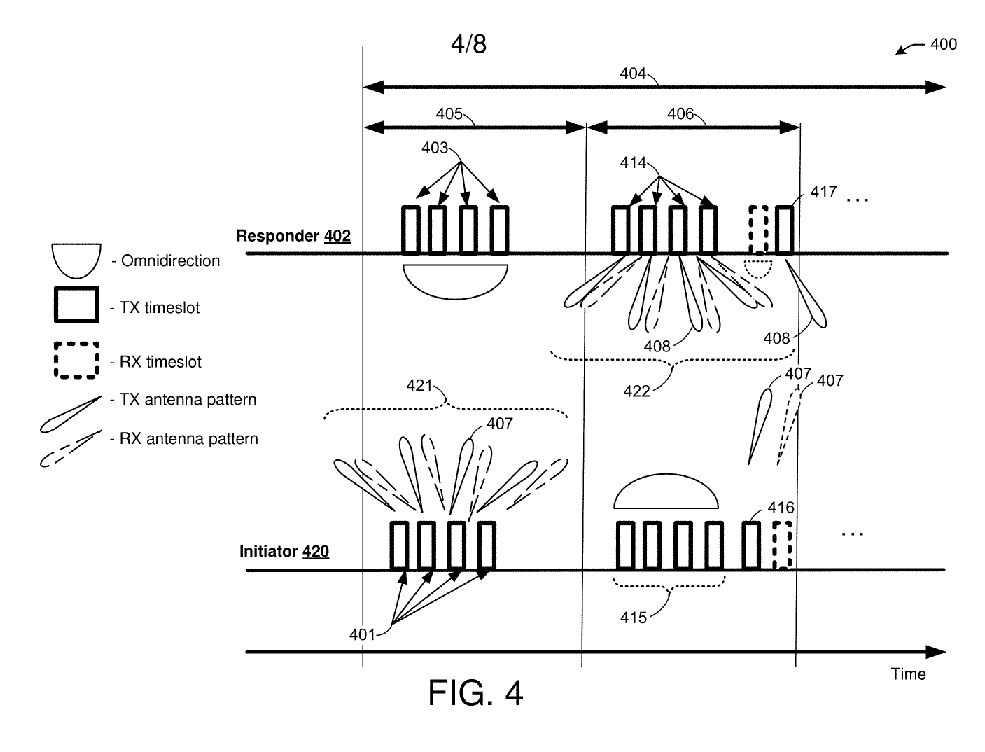

FIG. 4 depicts an illustrative schematic diagram 400 for analog beamforming, in accordance with one or more example embodiments of the present disclosure.

Referring to FIG. 4, an analog beamforming system may facilitate that one or more feedback frames may replace the one or more RTS frames when it is the responder device's turn to sweep through the various sectors.

Referring to FIG. 4, there is shown a first phase 404 that may consist of link acquisition using analog beamforming. Two timeslots are shown, timeslot 405 and timeslot 406.

In timeslots 405 and 406, an initiator device 420 and a responder device 402 (e.g., the user devices 120 of FIG. 1 and/or the AP 102 of FIG. 1) may be communicating with each other by sending and/or receiving one or more frames in one or more analog directions. The initiator device 420 and the responder device 402 may comprise one or more RF chains and one or more antennas. In this example, the number of RF chains is less than or equal to the number of antennas on each of the initiator device 420 and the responder device 402. The initiator device 420 and the responder device 402 may be 802.11 devices (e.g., 2.4 GHz, 5 GHz, or 6 GHz devices).

In one or more embodiments, the initiator device 420 may send one or more frames (e.g., RTS frames 401) in one or more analog directions 421, where each of the analog directions 421 is linked to the same RF chain. The initiator device 420 in this case may perform a complete sweep of all of its antennas using the one or more analog directions 421 when sending the one or more frames (e.g., RTS frames 401). The responder device 402 may then send one or more response frames (e.g., CTS frames 403) omnidirectionally. In this scenario, instead of sending a feedback frame from the responder device 402 to the initiator device 420 indicating the best analog direction of one of the received RTS frames 401, the responder device 402 may send a sweep of feedback frames 414 in all analog directions 422 using the same RF chain on the responder device 402. Further, instead of sending one or more RTS frames from the responder device 402, the responder device 402 may send a sweep of feedback frames 414. An issue with sending RTS frames is that it prevents other neighboring devices from communicating during the time the RTS frames are being sent. In order to minimize that limitation, instead of sending a sweep of RTS frames from the responder device 402 to the initiator device 420, the responder device 402 sends a sweep of feedback frames 414 to the initiator device 420. The sweep of feedback frames 414 includes, at least in part, an indication of the best analog direction of the RTS frames 401 sent from the initiator device 420 in the timeslot 405. Similarly, the initiator device 420 responds by sending, omnidirectionally, acknowledgment frames 415 acknowledging the feedback frames 414 received from the responder device 402 and the initiator device 420 may send a feedback frame 416 comprising an indication of the best analog direction (direction 408) of the sweep of feedback frames 414 received from the responder device 402. The initiator device 420 sends the feedback frame 416 in the same direction (direction 407) that was indicated as the best analog direction of the RTS frames 401 sent from the initiator device 420 in the timeslot 405. The responder device 402 may listen for the feedback frame (e.g., feedback frame 416) from the initiator device 420 omnidirectionally because it still does not know what its best analog direction is. Once the responder device 402 receives the feedback frame 416, the responder device 402 determines based on information included in the feedback frame 416, which direction (e.g., direction 408) is its best analog direction to use for sending frames. The responder device 402 may then respond to the feedback frame 416 received from the initiator device 420 by sending an acknowledgment frame 417 using the best analog direction 408. It is understood that the above descriptions are for purposes of illustration and are not meant to be limiting.

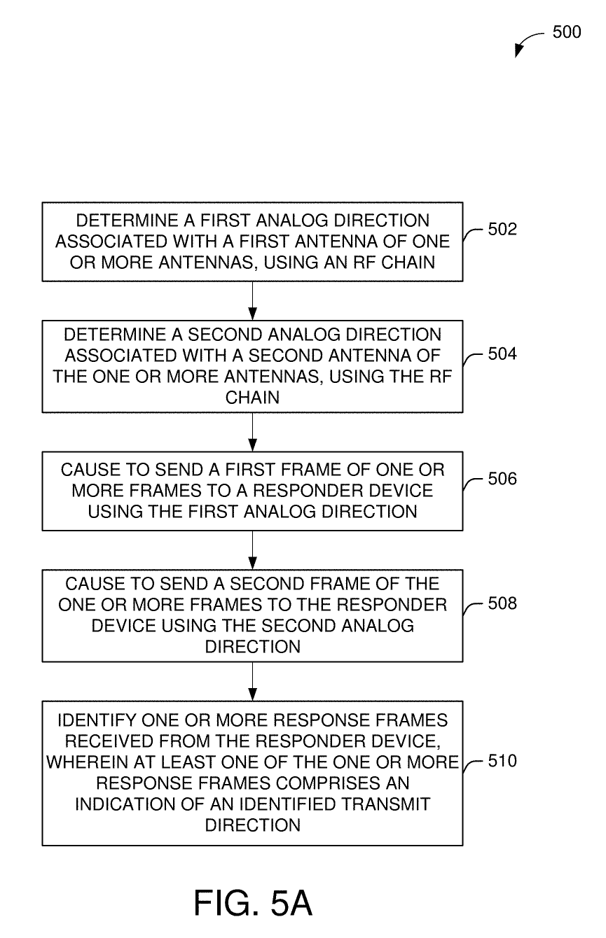

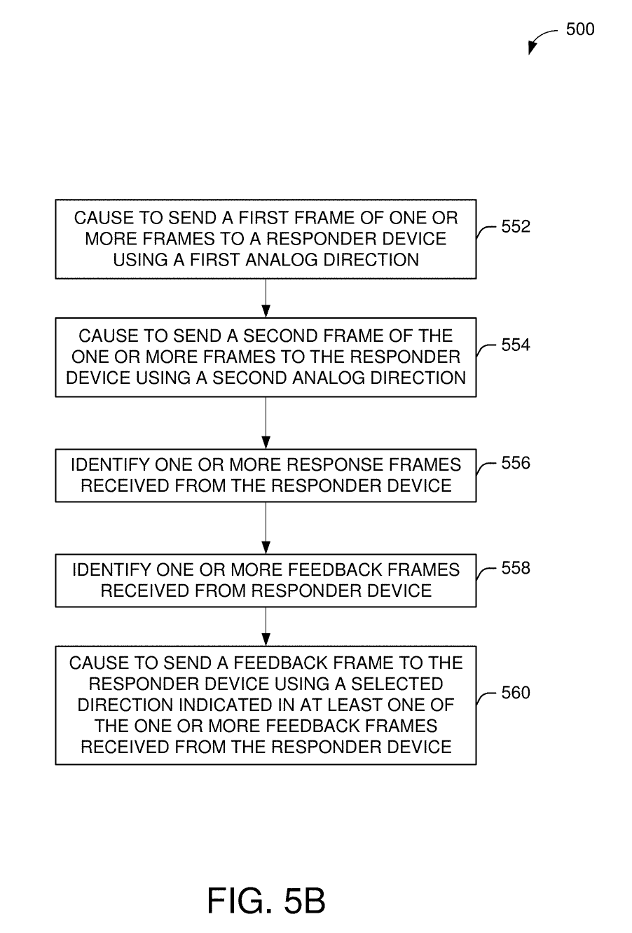

FIG. 5A illustrates a flow diagram of an illustrative process 500 for an illustrative analog beamforming system, in accordance with one or more example embodiments of the present disclosure.

At block 502, a device (e.g., the user device(s) 120 and/or the AP 102 of FIG. 1) may determine a first analog direction associated with a first antenna of one or more antennas, using an RF chain. For example, an initiator device may perform a link acquisition mechanism using one or more 802.11 frames (e.g., 2.4 GHz, 5 GHz, or 6 GHz frames).

At block 504, the device may determine a second analog direction associated with a second antenna of the one or more antennas, using the RF chain.

At block 506, the device may cause to send a first frame of one or more frames to a responder device using the first analog direction. For example, the initiator device may begin by sending multiple request to send (RTS) frames each in a different direction. The initiator device may send one or more frames (e.g., RTS frames) in one or more analog directions, where each analog direction is linked to the same RF chain. An analog direction may be associated with an analog chain that may be accomplished by varying antenna parameters in order to direct the antenna in a specific direction, referred to hereinafter as analog direction.

At block 508, the device may cause to send a second frame of the one or more frames to the responder device using the second analog direction.

At block 510, the device may identify one or more response frames received from the responder device, wherein at least one of the one or more response frames comprises an indication of an identified transmit direction. In one example, the responder may send one or more response frames (e.g., CTS frames) omnidirectionally. The initiator in this case may perform a complete sweep of all its antennas using analog directions and wait for feedback on which of these analog directions is the best direction for sending and receiving additional frames. After the responder sends its one or more response frames, it sends a feedback frame to the initiator. The feedback frame is a physical layer (PHY) protocol data unit (PPDU) that indicates which direction is the best direction for receiving one of the RTS frames. The initiator may receive the feedback omnidirectionally, may determine from the feedback the best direction, and uses that direction to send its acknowledgment frame to the feedback frame. Following that, the responder may then perform its own sweep of the RTS frames sent to the initiator by sweeping all of its antennas using analog directions. The initiator would then send response frames in the determined best analog direction and listens for incoming frames using that same analog direction. The initiator would then determine a direction for the RTS frames received from the responder that is the best direction and reports that to the responder in a feedback frame. The feedback frame may be sent using the initiator's best direction that was determined from the first feedback frame received from the responder. The responder may listen for the feedback frame omnidirectionally. The responder may determine its own best direction, which is indicated in the received feedback frame. The responder may then send an acknowledgment using that best direction.

It is understood that the above descriptions are for purposes of illustration and are not meant to be limiting.

FIG. 5B illustrates a flow diagram of illustrative process 550 for an analog beamforming system, in accordance with one or more example embodiments of the present disclosure.

At block 552, a device (e.g., the user device(s) 120 and/or the AP 102 of FIG. 1) may cause to send a first frame of one or more frames to a responder device using a first analog direction. For example, an initiator device may send one or more RTS frames, or other management frames, to a responder device. The initiator device and the responder device may comprise one or more RF chains and one or more antennas. In this example, the number of RF chains is less than or equal to the number of antennas on each of the initiator device and the responder device. The initiator device and the responder device may be 802.11 devices (e.g., 2.4 GHz, 5 GHz, or 6 GHz devices).

At block 554, the device may cause to send a second frame of the one or more frames to the responder device using a second analog direction. The second frame may be an RTS frame of the one or more RTS frames, or another management frame.

At block 556, the device may identify one or more response frames received from the responder device. For example, the responder device may send one or more response frames (e.g., CTS frames 403) omnidirectionally to the initiator device.

At block 558, the device may identify one or more feedback frames received from responder device. In this scenario, instead of sending a feedback frame from the responder device as was done in FIGS. 2 and 3, to the initiator device indicating the best analog direction of one of the received RTS frames, the responder device may send a sweep of feedback frames in all analog directions using the same RF chain on the responder device. Further, instead of sending one or more RTS frames from the responder device, the responder device may send a sweep of feedback frames.

At block 560, the device may cause to send a feedback frame to the responder device using a selected direction indicated in at least one of the one or more feedback frames received from the responder device. The initiator device sends the feedback frame in the same direction (direction 407 of FIG. 4) that was indicated as the best analog direction of the RTS frames sent from the initiator device. The responder device may listen for the feedback frame the initiator device omnidirectionally because it still does not know what its best analog direction is.

It is understood that the above descriptions are for purposes of illustration and are not meant to be limiting.

FIG. 6 shows a functional diagram of an exemplary communication station 600 in accordance with some embodiments. In one embodiment, FIG. 6 illustrates a functional block diagram of a communication station that may be suitable for use as an AP 102 (FIG. 1) or a user device 120 (FIG. 1) in accordance with some embodiments. The communication station 600 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 602 may include communications circuitry 602 and a transceiver 610 for transmitting and receiving signals to and from other communication stations using one or more antennas 601. The transceiver 610 may be a device comprising both a transmitter and a receiver that are combined and share common circuitry (e.g., communications circuitry 602). The communications circuitry 602 may include amplifiers, filters, mixers, analog to digital and/or digital to analog converters. The transceiver 610 may transmit and receive analog or digital signals. The transceiver 610 may allow reception of signals during transmission periods. This mode is known as full-duplex, and may require the transmitter and receiver to operate on different frequencies to minimize interference between the transmitted signal and the received signal. The transceiver 610 may operate in a half-duplex mode, where the transceiver 610 may transmit or receive signals in one direction at a time.

The communications circuitry 602 may include circuitry that can operate the physical layer (PHY) communications and/or media access control (MAC) communications for controlling access to the wireless medium, and/or any other communications layers for transmitting and receiving signals. The communication station 600 may also include processing circuitry 606 and memory 608 arranged to perform the operations described herein. In some embodiments, the communications circuitry 602 and the processing circuitry 606 may be configured to perform operations detailed in FIGS. 1, 2, 3, 4, 5A and 5B.

In accordance with some embodiments, the communications circuitry 602 may be arranged to contend for a wireless medium and configure frames or packets for communicating over the wireless medium. The communications circuitry 602 may be arranged to transmit and receive signals. The communications circuitry 602 may also include circuitry for modulation/demodulation, upconversion/downconversion, filtering, amplification, etc. In some embodiments, the processing circuitry 606 of the communication station 600 may include one or more processors. In other embodiments, two or more antennas 601 may be coupled to the communications circuitry 602 arranged for sending and receiving signals. The memory 608 may store information for configuring the processing circuitry 606 to perform operations for configuring and transmitting message frames and performing the various operations described herein. The memory 608 may include any type of memory, including non-transitory memory, for storing information in a form readable by a machine (e.g., a computer). For example, the memory 608 may include a computer-readable storage device, read-only memory (ROM), random-access memory (RAM), magnetic disk storage media, optical storage media, flash-memory devices and other storage devices and media.

In some embodiments, the communication station 600 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 600 may include one or more antennas 601. The antennas 601 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 600 may include one or more of a keyboard, a display, a non-volatile memory port, multiple antennas, a graphics processor, an application processor, speakers, and other mobile device elements. The display may be an LCD screen including a touch screen.

Although the communication station 600 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASIC s), radio-frequency integrated circuits (RFICs) and combinations of various hardware and logic circuitry for performing at least the functions described herein. In some embodiments, the functional elements of the communication station 600 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 600 may include one or more processors and may be configured with instructions stored on a computer-readable storage device memory.

FIG. 7 illustrates a block diagram of an example of a machine 700 or system upon which any one or more of the techniques (e.g., methodologies) discussed herein may be performed. In other embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environments. The machine 700 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the execution units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a power management device 732, a graphics display device 710, an alphanumeric input device 712 (e.g., a keyboard), and a user interface (UI) navigation device 714 (e.g., a mouse). In an example, the graphics display device 710, alphanumeric input device 712, and UI navigation device 714 may be a touch screen display. The machine 700 may additionally include a storage device (i.e., drive unit) 716, a signal generation device 718 (e.g., a speaker), an analog beamforming device 719, a network interface device/transceiver 720 coupled to antenna(s) 730, and one or more sensors 728, such as a global positioning system (GPS) sensor, a compass, an accelerometer, or other sensor. The machine 700 may include an output controller 734, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)).

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within the static memory 706, or within the hardware processor 702 during execution thereof by the machine 700. In an example, one or any combination of the hardware processor 702, the main memory 704, the static memory 706, or the storage device 716 may constitute machine-readable media.

The analog beamforming device 719 may carry out or perform any of the operations and processes (e.g., processes 500 and 550) described and shown above.

The analog beamforming device 719 may facilitate using IEEE 802.11 (e.g., 2.4 GHz, 5 GHz, or 6 GHz devices) as its foundation. Some examples of these frames may be request to send (RTS) and/or clear to send (CTS) or any management frame or acknowledgment (ACK). There are no known solutions standards based that are simple and easy to implement to address directional beamforming in 802.11 solutions using a similar use case as mmWave.

In one or more embodiments, an analog beamforming system may facilitate an analog hybrid beamforming scheme that is applicable for Wi-Fi products that are based on 802.11 (e.g., 2.4 GHz, 5 GHz, or 6 GHz). Multiple antennas may use the same hardware to process the radio signal. In this case, only one antenna can transmit or receive at a time because all radio signals need to go through the single RF chain. In multiple-input, multiple-output (MIMO), there can be a separate RF chain for each antenna allowing multiple RF chains to coexist. However, there are hardware limitations to the number of RF chains compared to having additional antennas. That is, an 802.11 device (e.g., 2.4 GHz, 5 GHz, or 6 GHz device) could have a larger number of antennas than RF chains. A typical Wi-Fi router has four antennas and four RF chains, and streams can be transmitted on all four RF chains. However, a situation arises when additional antennas are available but the number of RF chains stay the same. For example, there are four RF chains but there are eight antennas that are available. Although the four RF chains are used, the additional antennas may also be used.

The analog beamforming device 719 may perform a link acquisition mechanism using one or more 802.11 frames (e.g., 2.4 GHz, 5 GHz, or 6 GHz frames). For example, an initiator may begin by sending multiple request to send (RTS) frames each in a different direction. The responder may listen in an omnidirectional mode. As soon as the responder hears one successful RTS frame, then the responder sends it clear to send (CTS) frame. That is, the initiator may not have sent the RTS frames on all antennas in all directions but only a subset of the antennas and the directions. The initiator in effect may be waiting to determine the direction in which an RTS frame is received successfully on the responder side. The responder sends a CTS frame when it successfully receives one of the RTS frames sent from the initiator. Once the initiator receives a CTS frame from the responder, it keeps the direction for which it transmitted the successful RTS frame and uses it for receiving additional frames coming from the responder. The responder may then performs it sweep by sending multiple RTS frames each in a different direction. Note that to add robustness, multiple RTS frames could be sent in the same direction. The initiator would then send its CTS frame using the direction that it used when it transmitted the successful RTS frame. The analog beamforming allows the RTS frames to be sent with a sharp beam because of the additional antennas compared to the RF chains. The more antennas that are used, the sharper the beam. However, an analog beamforming system may facilitate exciting different directions using 802.11 frames, such as RTS, CTS, or any management or acknowledgment frames (e.g., 2.4 GHz, 5 GHz, or 6 GHz frames).

The analog beamforming device 719 may facilitate that each RTS frame is sent by the initiator in a specific transmit direction, and the initiator may set the receive direction to be the same as the transmit direction.

The analog beamforming device 719 may determine to send (or excite) a frame (e.g., an RTS frame) in a direction associated with an antenna using analog beamforming even though there is, for example, one RF chain.

The analog beamforming device 719 may facilitate that if there are more antennas than RF chains, each of the antennas may switch to a different direction while being linked to the RF chains. For example, if there is one RF chain but there are four antennas, each of the four antennas may have a specific direction while still being linked to the same RF chain.

The analog beamforming device 719 may facilitate that an initiator may send one or more frames (e.g., RTS frames) in one or more analog directions, where each analog direction is linked to the same RF chain. An analog direction may be associated with an analog chain that may be accomplished by varying antenna parameters to direct the antenna in a specific direction, referred to hereinafter as analog direction. The responder may then send one or more response frames (e.g., CTS frames) omnidirectionally. The initiator here may perform a complete sweep of all its antennas using analog directions and wait for feedback on which of these analog directions is the best direction for sending and receiving additional frames. After the responder sends its one or more response frames, it sends a feedback frame to the initiator. The feedback frame is a physical layer (PHY) protocol data unit (PPDU) that indicates which direction is the best direction for receiving one of the RTS frames. The initiator may receive the feedback omnidirectionally and may determine from the feedback the best direction and uses that direction to send its acknowledgment frame to the feedback frame. Following that, the responder may then perform its own sweep of the RTS frames sent to the initiator by sweeping all of its antennas using analog directions. The initiator would then send response frames in the determined best analog direction and also listens for incoming frames using that same analog direction. The initiator would then determine a direction for the RTS frames received from the responder that is the best direction and reports that to the responder in a feedback frame. The feedback frame may be sent using the initiator's best direction that was determined from the first feedback frame received from the responder. The responder may listen for the feedback frame omnidirectionally. The responder may determine its own best direction, which is indicated in the received feedback frame. The responder may then send an acknowledgment using that best direction.

The analog beamforming device 719 may facilitate that an initiator may send one or more frames (e.g., RTS frames) in one or more analog directions, where each analog direction is linked to the same RF chain. The initiator here may perform a complete sweep of all of its antennas using analog directions when sending the one or more frames. The responder may then send one or more response frames (e.g., CTS frames) omnidirectionally. In this scenario, instead of sending a feedback frame from the responder to the initiator indicating the best analog direction of one of the received RTS frames, the responder may send a sweep of feedback frames in all analog directions using the same RF chain. One issue with sending RTS frames is that it prevents other neighboring devices from communicating during the time the RTS frames are being sent. In order to minimize that limitation, instead of sending a sweep of RTS frames from the responder to the initiator, the responder sends a sweep of feedback frames to the initiator. The sweep of feedback frames comprises an indication of the best analog direction of the most recently RTS frames sent from the initiator. Similarly, the initiator responds by sending, omnidirectionally, acknowledgment frames to the feedback frames received from the responder and also sends a feedback frame comprising an indication of the best analog direction of the sweep of feedback frames received from the responder. The initiator sends the feedback frame in the same direction that was indicated as the best analog direction of the RTS frames sent from the initiator in the previous timeslot. The responder listens for the feedback frame from the initiator omnidirectionally because it still does not know what its best analog direction is. Once the responder receives the feedback frame, the responder determines, based on information included in the feedback frame, which direction is its best analog direction to use for sending frames. The responder may then respond to the feedback frame received from the initiator by sending an acknowledgment using that best analog direction.

It is understood that the above are only a subset of what the analog beamforming device 719 may be configured to perform and that other functions included throughout this disclosure may also be performed by the analog beamforming device 719.

While the machine-readable medium 722 is illustrated as a single medium, the term “machine-readable medium” may include a single medium or multiple media (e.g., a centralized or distributed database, and/or associated caches and servers) configured to store the one or more instructions 724.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 700 and that cause the machine 700 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device/transceiver 720 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 720 may include one or more physical jacks (e.g., Ethernet, coaxial, or phone jacks) or one or more antennas to connect to the communications network 726. In an example, the network interface device/transceiver 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 700 and includes digital or analog communications signals or other intangible media to facilitate communication of such software. The operations and processes described and shown above may be carried out or performed in any suitable order as desired in various implementations. Additionally, in some implementations, at least a portion of the operations may be carried out in parallel. Furthermore, in some implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a single input single output (SISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following examples pertain to further embodiments.

Example 1 may include a device comprising memory and processing circuitry configured to: determine a first analog direction associated with a first antenna of one or more antennas, using an RF chain; determine a second analog direction associated with a second antenna of the one or more antennas, using the RF chain; cause to send a first frame of one or more frames to a responder device using the first analog direction; cause to send a second frame of the one or more frames to the responder device using the second analog direction; and identify one or more response frames received from the responder device, wherein at least one of the one or more response frames comprises an indication of an identified transmit direction.

Example 2 may include the device of example 1 and/or some other example herein, wherein the one or more frames are request to send (RTS) frames.

Example 3 may include the device of example 2 and/or some other example herein, wherein the one or more response frames are clear to send (CTS) frames.

Example 4 may include the device of example 1 and/or some other example herein, wherein the device may be an 802.11 device capable of operating in at least one of 2.4 GHz, 5 GHz, or 6 GHz.

Example 5 may include the device of example 1 and/or some other example herein, wherein the identified transmit direction may be the second analog direction, and wherein the second analog direction may be associated with a successful reception of the second frame by the responder device.

Example 6 may include the device of example 5 and/or some other example herein, wherein the memory and the processing circuitry are further configured to: identify one or more RTS frames received from the responder device; and cause to send a CTS frame using the second analog direction.

Example 7 may include the device of example 6 and/or some other example herein, wherein the one or more RTS frames are received after receiving the one or more response frames from the responder device.

Example 8 may include the device of example 1 and/or some other example herein, wherein the memory and the processing circuitry are further configured to: identify a feedback frame received from the responder device, wherein the feedback frame comprises a selected direction associated with sending the first frame and the second frame; and cause to send to the responder device an acknowledgment frame using the selected direction indicated in the feedback frame.

Example 9 may include the device of example 8 and/or some other example herein, wherein the feedback frame may be received omnidirectionally.

Example 10 may include the device of example 1 and/or some other example herein, further comprising a transceiver configured to transmit and receive wireless signals.

Example 11 may include the device of example 10 and/or some other example herein, further comprising one or more antennas coupled to the transceiver.

Example 12 may include a non-transitory computer-readable medium storing computer-executable instructions which when executed by one or more processors result in performing operations comprising: causing to send a first frame of one or more frames to a responder device using a first analog direction; causing to send a second frame of the one or more frames to the responder device using a second analog direction; identifying one or more response frames received from the responder device; identifying one or more feedback frames received from responder device; and causing to send a feedback frame to the responder device using a selected direction indicated in at least one of the one or more feedback frames received from the responder device.

Example 13 may include the non-transitory computer-readable medium of example 12and/or some other example herein, wherein the one or more feedback frames are received omnidirectionally.

Example 14 may include the non-transitory computer-readable medium of example 12 and/or some other example herein, wherein the operations further comprise determining a direction associated with receiving at least one of the one or more feedback frames received from the responder device.

Example 15 may include the non-transitory computer-readable medium of example 14 and/or some other example herein, wherein the feedback frame comprises an indication of the direction associated with the one or more feedback frames received from the responder device.

Example 16 may include a method comprising: determining, by one or more processors of an initiator device, a first analog direction associated with a first antenna of one or more antennas, using an RF chain; determining a second analog direction associated with a second antenna of the one or more antennas, using the RF chain; causing to send a first frame of one or more frames to a responder device using the first analog direction; causing to send a second frame of the one or more frames to the responder device using the second analog direction; and identifying one or more response frames received from the responder device, wherein at least one of the one or more response frames comprises an indication of an identified transmit direction.

Example 17 may include the method of example 16 and/or some other example herein, wherein the one or more frames are request to send (RTS) frames.

Example 18 may include the method of example 17 and/or some other example herein, wherein the one or more response frames are clear to send (CTS) frames.

Example 19 may include the method of example 16 and/or some other example herein, wherein the initiator device and the responder device may be an 802.11 device capable of operating in at least one of 2.4 GHz, 5 GHz, or 6 GHz.

Example 20 may include the method of example 16 and/or some other example herein, wherein the identified transmit direction may be the second analog direction, and wherein the second analog direction may be associated with a successful reception of the second frame by the responder device.

Example 21 may include the method of example 16 and/or some other example herein, wherein the identified transmit direction may be the second analog direction, and wherein the second analog direction may be associated with a successful reception of the second frame by the responder device.

Example 22 may include an apparatus comprising means for: causing to send a first frame of one or more frames to a responder device using a first analog direction; causing to send a second frame of the one or more frames to the responder device using a second analog direction; identifying one or more response frames received from the responder device; identifying one or more feedback frames received from responder device; and causing to send a feedback frame to the responder device using a selected direction indicated in at least one of the one or more feedback frames received from the responder device.

Example 23 may include the apparatus of example 22 and/or some other example herein, wherein the one or more feedback frames are received omnidirectionally.

Example 24 may include the apparatus of example 22 and/or some other example herein, further comprising means for determining a direction associated with receiving at least one of the one or more feedback frames received from the responder device.

Example 25 may include the apparatus of example 24 and/or some other example herein, wherein the feedback frame comprises an indication of the direction associated with the one or more feedback frames received from the responder device.

Example 26 may include one or more non-transitory computer-readable media comprising instructions to cause an electronic device, upon execution of the instructions by one or more processors of the electronic device, to perform one or more elements of a method described in or related to any of examples 1-25, or any other method or process described herein.

Example 27 may include an apparatus comprising logic, modules, and/or circuitry to perform one or more elements of a method described in or related to any of examples 1-25, or any other method or process described herein.

Example 28 may include a method, technique, or process as described in or related to any of examples 1-25, or portions or parts thereof.

Example 29 may include an apparatus comprising: one or more processors and one or more computer readable media comprising instructions that, when executed by the one or more processors, cause the one or more processors to perform the method, techniques, or process as described in or related to any of examples 1-25, or portions thereof.

Example 30 may include a method of communicating in a wireless network as shown and described herein.

Example 31 may include a system for providing wireless communication as shown and described herein.

Example 32 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, the device comprising memory and processing circuitry configured to:
determine a first analog direction associated with a first antenna of one or more antennas, using an RF chain;
determine a second analog direction associated with a second antenna of the one or more antennas, using the RF chain;
cause to send a first frame of one or more frames to a responder device using the first analog direction;
cause to send a second frame of the one or more frames to the responder device using the second analog direction; and
identify one or more response frames received from the responder device, wherein at least one of the one or more response frames comprises an indication of an identified transmit direction.

2. The device of claim 1, wherein the one or more frames are request to send (RTS) frames.

3. The device of claim 2, wherein the one or more response frames are clear to send (CTS) frames.

4. The device of claim 1, wherein the device is an 802.11 device capable of operating in at least one of 2.4 GHz, 5 GHz, or 6 GHz.

5. The device of claim 1, wherein the identified transmit direction is the second analog direction, and wherein the second analog direction is associated with a successful reception of the second frame by the responder device.

6. The device of claim 5, wherein the memory and the processing circuitry are further configured to:
identify one or more RTS frames received from the responder device; and
cause to send a CTS frame using the second analog direction.

7. The device of claim 6, wherein the one or more RTS frames are received after receiving the one or more response frames from the responder device.

8. The device of claim 1, wherein the memory and the processing circuitry are further configured to:
identify a feedback frame received from the responder device, wherein the feedback frame comprises a selected direction associated with sending the first frame and the second frame; and
cause to send to the responder device an acknowledgment frame using the selected direction indicated in the feedback frame.

9. The device of claim 8, wherein the feedback frame is received omnidirectionally.

10. The device of claim 1, further comprising a transceiver configured to transmit and receive wireless signals.

11. The device of claim 10, further comprising one or more antennas coupled to the transceiver.

12. A non-transitory computer-readable medium storing computer-executable instructions which when executed by one or more processors result in performing operations comprising:
causing to send a first frame of one or more frames to a responder device using a first analog direction;
causing to send a second frame of the one or more frames to the responder device using a second analog direction;
identifying one or more response frames received from the responder device;
identifying one or more feedback frames received from responder device; and
causing to send a feedback frame to the responder device using a selected direction indicated in at least one of the one or more feedback frames received from the responder device.

13. The non-transitory computer-readable medium of claim 12, wherein the one or more feedback frames are received omnidirectionally.

14. The non-transitory computer-readable medium of claim 12, wherein the operations further comprise determining a direction associated with receiving at least one of the one or more feedback frames received from the responder device.

15. The non-transitory computer-readable medium of claim 14, wherein the feedback frame comprises an indication of the direction associated with the one or more feedback frames received from the responder device.

16. A method comprising:
determining, by one or more processors of an initiator device, a first analog direction associated with a first antenna of one or more antennas, using an RF chain;
determining a second analog direction associated with a second antenna of the one or more antennas, using the RF chain;
causing to send a first frame of one or more frames to a responder device using the first analog direction;
causing to send a second frame of the one or more frames to the responder device using the second analog direction; and
identifying one or more response frames received from the responder device, wherein at least one of the one or more response frames comprises an indication of an identified transmit direction.

17. The method of claim 16, wherein the one or more frames are request to send (RTS) frames.

18. The method of claim 17, wherein the one or more response frames are clear to send (CTS) frames.

19. The method of claim 16, wherein the initiator device and the responder device is an 802.11 device capable of operating in at least one of 2.4 GHz, 5 GHz, or 6 GHz.

20. The method of claim 16, wherein the identified transmit direction is the second analog direction, and wherein the second analog direction is associated with a successful reception of the second frame by the responder device.
